(19) United States
(12) Patent Application Publication
(10) Pub. No.: US 2025/0044104 A1
(43) Pub. Date: Feb. 6, 2025

(54) POSITION CALCULATING APPARATUS, ASSISTANCE CONTROLLING APPARATUS, POSITION CALCULATING METHOD, AND COMPUTER-READABLE STORAGE MEDIUM

(71) Applicant: HONDA MOTOR CO.,LTD., Tokyo (JP)

(72) Inventors: Moriya HORIUCHI, Saitama (JP); Takahiro KUREHASHI, Saitama (JP); Yuta SAKAGAWA, Saitama (JP)

(21) Appl. No.: 18/738,048

(22) Filed: Jun. 9, 2024

(30) Foreign Application Priority Data
Jul. 31, 2023 (JP) 2023-124170

(51) Int. Cl. G01C 21/28; G08G 1/052

(52) U.S. Cl. CPC G01C 21/28; G08G 1/052

(57) ABSTRACT

A position calculating apparatus includes an acquiring unit which acquires position information of each of a plurality of moving objects and acquisition time information of each of the position information, a calculating unit which calculates a position of each of the plurality of moving objects at a future time based on the position information and the acquisition time information, and a setting unit which sets the future time by at least taking into account a calculation start time which is the time when the calculating unit starts calculating the position of each of the plurality of moving objects, and a first required time which is the time necessary for calculating the position of each of the plurality of moving objects.

The contents of the following patent application(s) are incorporated herein by reference:
NO. 2023-124170 filed in JP on Jul. 31, 2023.

### BACKGROUND

### 1. Technical Field

The present invention relates to a position calculating apparatus, assistance controlling apparatus, position calculating method, and a computer-readable storage medium.

### 2. Related Art

In recent years, efforts have been intensified to provide access to a sustainable transportation system with consideration given to even vulnerable people among other traffic participants. To realize this, research and development has been focused on to even further improve traffic safety and convenience through research and development regarding a preventive safety technology. Patent Documents 1 to 3 describe a technology regarding calculating a position of a vehicle.

### PRIOR ART DOCUMENT

### Patent Documents

Patent Document 1: Japanese Patent Application Publication No. 2020-91717
Patent Document 2: Japanese Patent Application Publication No. 2007-280060
Patent Document 3: Japanese Patent Application Publication No. 2009-222438

### BRIEF DESCRIPTION OF THE DRAWINGS

FIG. 1 schematically shows a usage scene of an assistance system 10.

FIG. 2 shows a functional configuration of an assistance apparatus 60.

FIG. 3 is a diagram for describing one example of processing to determine time at which positions of the vehicle 20 and the user terminal 82 are to be calculated.

FIG. 4 is a diagram for describing another example of processing to determine the time at which positions of the vehicle 20 and the user terminal 82 are to be calculated.

FIG. 5 shows one example of an execution sequence of processing by the user terminal 82, the in-vehicle processing apparatus 40 included in the vehicle 20, and the assistance apparatus 60.

FIG. 6 shows one example of a flowchart regarding an assistance controlling method performed by the assistance apparatus 60.

FIG. 7 shows an example of a computer 2000.

### DESCRIPTION OF EXEMPLARY EMBODIMENTS

Hereinafter, embodiments of the present invention will be described. However, the following embodiments are not for limiting the invention according to the claims. In addition, not all of the combinations of features described in the embodiments are essential to the solving means of the invention.

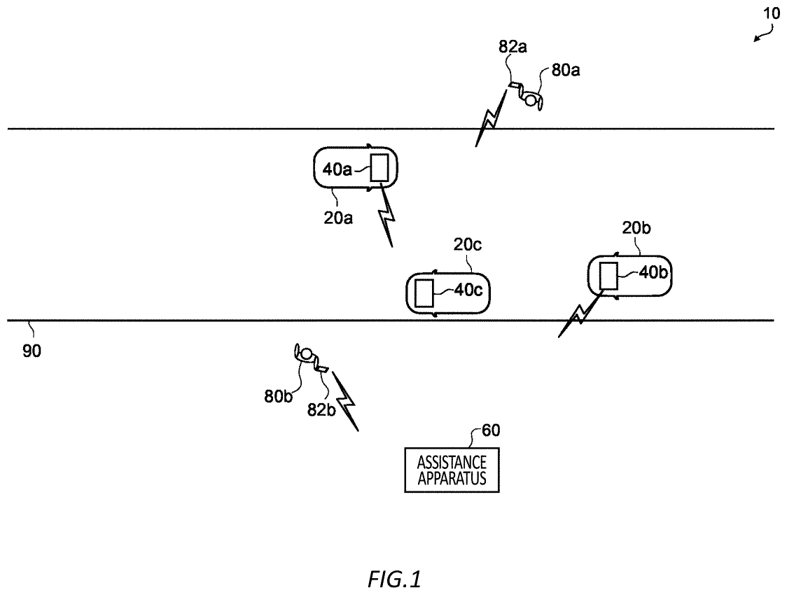

FIG. 1 schematically shows a usage scene of an assistance system 10. The assistance system 10 includes a vehicle 20a, a vehicle 20b, and a vehicle 20c, a user terminal 82a and a user terminal 82b, and an assistance apparatus 60.

The vehicle 20a includes an in-vehicle processing apparatus 40a, the vehicle 20b includes an in-vehicle processing apparatus 40b, and the vehicle 20c includes an in-vehicle processing apparatus 40c. The vehicle 20a and the vehicle 20b are traveling vehicles, and the vehicle 20c is a stopped vehicle. The user terminal 82a is a terminal carried by a user 80a, and the user terminal 82b is a terminal carried by a user 80b. In the present embodiment, the user 80a and the user 80b are pedestrians.

In the present embodiment, the vehicle 20a, the vehicle 20b, and the vehicle 20c may be collectively referred to as “vehicle(s) 20”. The in-vehicle processing apparatus 40a, the in-vehicle processing apparatus 40b, and the in-vehicle processing apparatus 40c may be collectively referred to as “in-vehicle processing apparatus(es) 40”. The user terminal 82a and the user terminal 82b may be collectively referred to as a “user terminal 82”. The user 80a and the user 80b may be collectively referred to as a “user 80”.

The vehicle 20 is a vehicle which travels on a road 90. The vehicle 20 is one example of a moving object. The in-vehicle processing apparatus 40 includes a camera, a position sensor including a Global Navigation Satellite System (GNSS) receiver, and a speed sensor such as a vehicle speed sensor. The in-vehicle processing apparatus 40 has a function of processing information acquired by various sensors and a function of communicating with the assistance apparatus 60. The in-vehicle processing apparatus 40 provides an advanced driver-assistance systems (ADAS) function included in the vehicle 20.

The user terminal 82 is a mobile terminal such as a smartphone, for example. The user terminal 82 is one example of the moving object. The user terminal 82 periodically transmits to the assistance apparatus 60 current position information of the user terminal 82 detected by the position sensor including the GNSS receiver.

The assistance apparatus 60 receives information transmitted from the in-vehicle processing apparatus 40 and the user terminal 82 through mobile communication. The assistance apparatus 60 may receive the information transmitted from the in-vehicle processing apparatus 40 and the user terminal 82 through the mobile communication as well as a communication line such as Internet and a dedicated line.

The assistance apparatus 60 provides traffic assistance for the vehicle 20 based on information received from the in-vehicle processing apparatus 40 and the user terminal 82. For example, if the user 80 and the vehicle 20 are predicted to approach within a predetermined time based on a history of position information and speed information of the vehicle 20 a and a history of position information of the user terminal 82 received from the in-vehicle processing apparatus 40a, the assistance apparatus 60 determines to provide the traffic assistance for the vehicle 20 and the user 80 and instructs the in-vehicle processing apparatus 40a and the user terminal 82a to output a warning.

The assistance apparatus 60 determines whether the user 80 and the vehicle 20 will approach within a predetermined time by calculating position of each of the vehicle 20a and the user terminal 82a at a point in time later by the predetermined time than a present time. At this time, the assistance apparatus 60 takes into account a first required time which is necessary for calculating the position of each of the vehicle 20a and the user terminal 82a to determine at which point in time the positions are to be calculated. For example, when calculating the positions of the vehicle 20a and the user terminal 82a at 5 seconds later to determine whether the user 80 and the vehicle 20 will approach 5 seconds later, the assistance apparatus 60 determines a point in time when the first required time further elapses from the 5 seconds as a point in time to calculate the positions of the vehicle 20a and the user terminal 82a. This allows an accurate determination of whether the user 80 and the vehicle 20 will approach 5 seconds later, at a point in time when the calculation of the positions is complete.

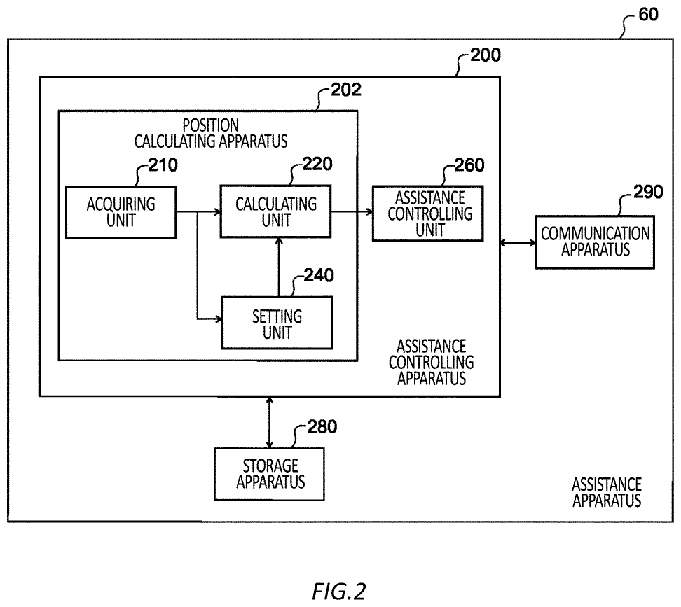

FIG. 2 shows a functional configuration of the assistance apparatus 60. The assistance apparatus 60 includes an assistance controlling apparatus 200, a communication apparatus 290, and a storage apparatus 280. The assistance controlling apparatus 200 includes a position calculating apparatus 202 and an assistance controlling unit 260.

The communication apparatus 290 provides communication between the assistance apparatus 60 and each of the in-vehicle processing apparatus 40 and the user terminal 82. The assistance controlling unit 260 and the position calculating apparatus 202 is realized to include, for example, a circuit such as an arithmetic processing apparatus including a processor. The assistance controlling unit 260 and the position calculating apparatus 202 may be realized by a microcomputer including a CPU, a ROM, a RAM, an I/O, bus, and the like. The storage apparatus 280 is realized to include a non-volatile storage medium. The assistance controlling unit 260 and the position calculating apparatus 202 perform processing by using information stored in the storage apparatus 280.

The position calculating apparatus 202 includes an acquiring unit 210, a calculating unit 220, and a setting unit 240. It should be noted that a configuration may be adopted in which the assistance apparatus 60 does not have some functions in the functional configuration shown in FIG. 2.

The acquiring unit 210 acquires position information of each of a plurality of vehicles 20 and/or user terminals 82 and acquisition time information of each of the position information. The calculating unit 220 calculates a position of each of the plurality of vehicles 20 and/or user terminals 82 at a future time based on the position information and the acquisition time information. The setting unit 240 sets the future time by at least taking into account a calculation start time which is the time when the calculating unit 220 starts calculating the position of each of the plurality of vehicles 20 and/or user terminals 82, and the first required time which is the time necessary for calculating the position of each of the plurality of vehicles 20 and/or user terminals 82.

As one example, the setting unit 240 may set the future time based on time obtained by adding the first required time to the calculation start time.

The calculating unit 220 may calculate, for each of the plurality of vehicles 20 and/or user terminals 82, a time difference between the future time and acquisition time of a latest position of each of the vehicle 20 and/or the user terminal 82, and calculate the position of each of the vehicle 20 and/or the user terminal 82 at the future time based on the latest position of each of the vehicle 20 and/or the user terminal 82 and a moving speed of each of the vehicle 20 and/or the user terminal 82 and the time difference.

The setting unit 240 may measure a time required for the calculating unit 220 to calculate the position of each of the plurality of vehicles 20 and/or user terminals 82, and set the first required time used to set the future time based on the time measured. The setting unit 240 may set the first required time based on a number of the plurality of vehicles 20 and/or user terminals 82. The setting unit 240 may set the first required time based on a current processing load on the position calculating apparatus.

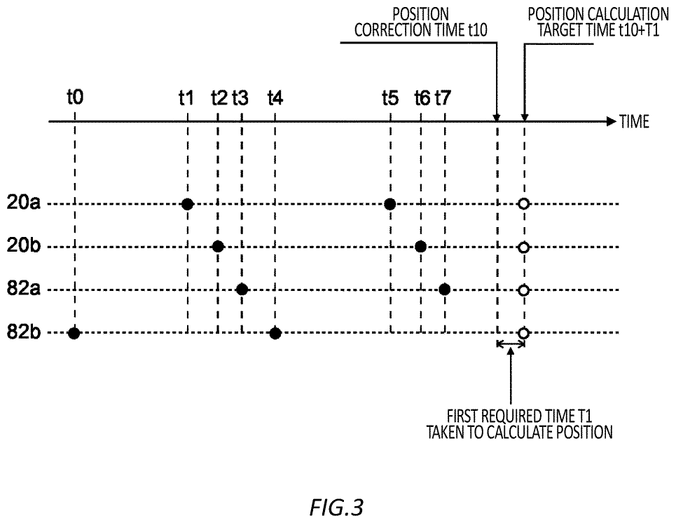

FIG. 3 is a diagram for describing one example of processing to determine the time at which the positions of the vehicle 20 and the user terminal 82 are to be calculated.

Each of the vehicle 20 and the user terminal 82 periodically transmits the position information indicating acquired current positions and the acquisition time information of the positions to the assistance apparatus 60. The acquiring unit 210 of the assistance apparatus 60 acquires the position information and the acquisition time information transmitted from each of the vehicle 20 and the user terminal 82. FIG. 3 shows a state in which the acquiring unit 210 received positions of the vehicle 20a at times t1 and t5, positions of the vehicle 20b at times t2 and t6, positions of the user terminal 82a at times t3 and t7, and positions of the user terminal 82b at times t0 and t4.

Since timing at which the vehicle 20 and the user terminal 82 acquire the current positions is not synchronized, there can be differences in the acquisition time of the positions, as illustrated. Therefore, the calculating unit 220 of the assistance apparatus 60 calculates positions at a specific point in time in the present or in the future, based on the position information and time information separately acquired by each of the vehicle 20 and the user terminal 82. The assistance controlling unit 260 performs control regarding the traffic assistance for the vehicle 20 and the user 80 based on the positions of the vehicle 20 and the user terminal 82 at a specific point in time.

As a first example, the assistance controlling unit 260 provides the traffic assistance such as notifying the vehicle 20 and the user 80 that they might approach another moving object if the vehicle 20 and the user terminal 82 are determined to approach within a predetermined distance at a point in time which is 5 seconds later from the present time and/or if the vehicle 20 and another vehicle 20 are determined to approach within the predetermined distance at a point in time which is 5 seconds later.

However, calculating the positions of the vehicle 20 and the user terminal 82 takes time. Therefore, assuming that the positions of the vehicle 20 and the user terminal 82 at 5 seconds later from the present time are calculated and the control regarding the traffic assistance is performed based on the calculated positions, if the first required time taken to calculate the positions of the vehicle 20 and the user terminal 82 is T1 second(s), the result is that the control regarding the traffic assistance is performed based on the positions at a point in time which is 5−T1 second(s) when viewed from the point in time when the control regarding the traffic assistance is started.

As a second example, in a case where the control regarding the traffic assistance is performed based on the positions of the vehicle 20 and the user terminal 82 at a present time, assuming that current positions of the vehicle 20 and the user terminal 82 at the present time are calculated, the result is that the control regarding the traffic assistance is performed based on the positions at a point in time which is T1 second(s) earlier when viewed from the point in time when the control regarding the traffic assistance is started.

Therefore, once a position correction time, which is the time at which the positions of the vehicle 20 and the user terminal 82 are calculated, is determined, the calculating unit 220 calculates the positions at a point in time which is later by at least a first required time T1 than the position correction time. Here, the position correction time is the time which is 5 seconds later from the present time in the first example described above, and the present time in the second example.

In the example in FIG. 3, for example, once a position correction time t10 is determined, the calculating unit 220 determines time obtained by adding the required time T1 to the position correction time t10 as a position calculation target time, and the calculating unit 220 calculates the positions of the vehicle 20 and the user terminal 82 at that time t10+T1. For example, the calculating unit 220 calculates the position of the vehicle 20a at the time t10+T1 based on the times t1 and t5 and the positions of the vehicle 20a at the times t1 and t5. Specifically, the calculating unit 220 calculates a speed of the vehicle 20 based on the position of the vehicle 20a at t5 and the position of the vehicle 20a at t1, and calculates the position of the vehicle 20a at the time t10+T1 based on the calculated speed and a travel time from the time t5 to the time t10+T1 (t10+T1−t5), and the position of vehicle 20a at the time t5. If the speed information of the vehicle 20a is included in information transmitted from the vehicle 20a, the calculating unit 220 may calculate the position of the vehicle 20a at the time t10+T1 by using the speed and the travel time (t10+T1−t5) indicated in that speed information and the position of the vehicle 20a at the time t5.

This allows the assistance controlling unit 260 to properly perform the control regarding the traffic assistance because the position at a point in time in the time t10+T1 has been calculated when it performs the control regarding the traffic assistance. For example, if it is determined that the vehicle 20a and the user 80a might approach 5 seconds later, the assistance controlling unit 260 can output an appropriate warning to an occupant and the user 80a by transmitting instructions to the in-vehicle processing apparatus 40a and the user terminal 82a to output a warning that the vehicle 20a and the user 80a might approach 5 seconds later.

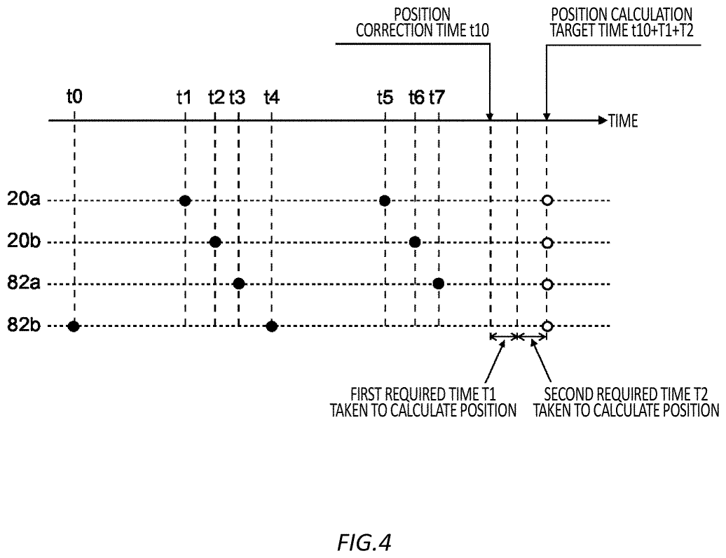

FIG. 4 is a diagram for describing another example of processing to determine the time at which positions of the vehicle 20 and the user terminal 82 are to be calculated. Here, with reference to FIG. 4, differences from the example in FIG. 3 are mainly described.

The example in FIG. 4 differs from the example in FIG. 3 in that the position calculation target time for the vehicle 20 and the user terminal 82 is determined by taking into account a second required time T2, which is the time taken for the assistance controlling unit 260 to perform processing to make an approach determination for the vehicle 20 and the user terminal 82. Specifically, the calculating unit 220 calculates the positions of the vehicle 20 and the user terminal 82 using time t10+T1+T2 as the position calculation target time.

The second required time T2 is the time necessary for the assistance controlling unit 260 to determine, based on the positions calculated by the calculating unit 220, whether the vehicle 20 and the user terminal 82 are approaching within the predetermined distance and/or whether the vehicle 20 and the another vehicle 20 are approaching within the predetermined distance. According to the example in FIG. 4, the calculating unit 220 can calculate the positions of the vehicle 20 and the user terminal 82 at the time t10+T1+T2, and the assistance controlling unit 260 can make the approach determination for the vehicle 20 and the user terminal 82 based on the calculated positions. Accordingly, if the position correction time t10 is a point in time which is 5 seconds later from the present time, for example, this means that, at a point in time when processing of the approach determination by the assistance controlling unit 260 is complete, the approach determination at a point in time which is 5 seconds later from that point in time was made. Therefore, an appropriate warning can be output to an occupant and the user 80a.

The first required time T1 and/or the second required time T2 may be predetermined fixed values. The first required time T1 and/or the second required time T2 may be dynamically set by the setting unit 240. The setting unit 240 may measure a time required for the calculating unit 220 to calculate the positions of the vehicle 20 and the user terminal 82 multiple times, and set the first required time T1 based on an average value of the time measured multiple times. The setting unit 240 may measure a time required in the above-described processing of the approach determination by the assistance controlling unit 260 multiple times, and set the second required time T2 based on an average value of the time measured multiple times.

The setting unit 240 may set the first required time T1 and/or the second required time T2 based on a number of the vehicle 20 and the user terminal 82 whose positions are to be calculated by the calculating unit 220. The setting unit 240 may set the first required time T1 and/or the second required time T2 longer as the number of the vehicle 20 and the user terminal 82 whose positions are to be calculated by the calculating unit 220 is greater. The setting unit 240 may set the first required time T1 by multiplying the number of the vehicle 20 and the user terminal 82 whose positions are to be calculated by the calculating unit 220 by the predetermined time. The setting unit 240 may set the second required time T2 longer as a number of combinations of the vehicle 20 and the user terminal 82 for which the assistance controlling unit 260 makes the approach determination is greater. The setting unit 240 may set the second required time T2 by multiplying the number of combinations of the vehicle 20 and the user terminal 82 for which the assistance controlling unit 260 makes the approach determination by the predetermined time.

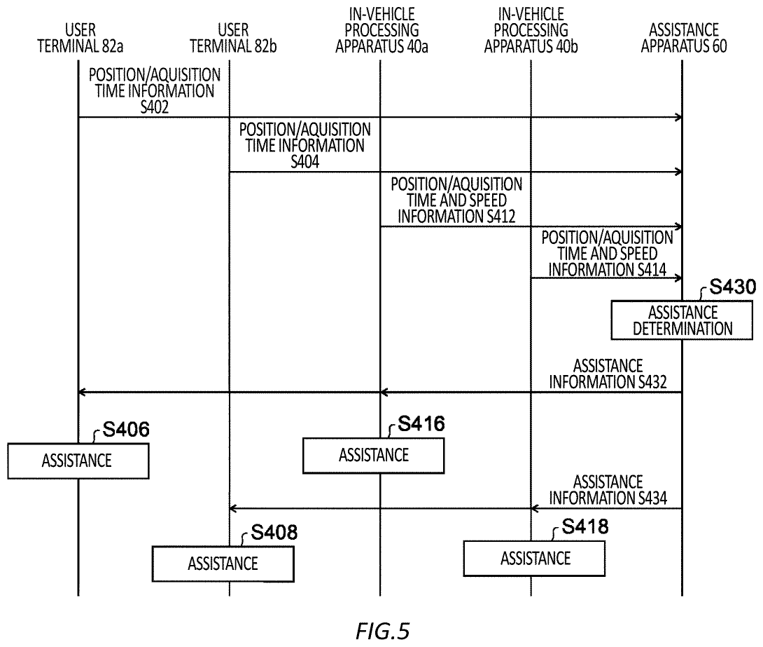

FIG. 5 shows one example of an execution sequence of processing by the user terminal 82, the in-vehicle processing apparatus 40 included in the vehicle 20, and the assistance apparatus 60.

At S402, the user terminal 82a transmits, to the assistance apparatus 60, the position information indicating a current position of the user terminal 82a which is based on a signal received from the GNSS satellite, and the acquisition time information indicating time when the current position was acquired. Transmission of the position information and the acquisition time information from the user terminal 82a to the assistance apparatus 60 is periodically performed.

At S404, the user terminal 82b transmits, to the assistance apparatus 60, the position information indicating a current position of the user terminal 82b which is based on a signal received from the GNSS satellite, and the acquisition time information indicating time when the current position was acquired. Transmission of the position information and the acquisition time information from the user terminal 82b to the assistance apparatus 60 is periodically performed.

At S412, the in-vehicle processing apparatus 40a transmits, to the assistance apparatus 60, the position information indicating a current position of the vehicle 20a which is based on the signal received from the GNSS satellite, the acquisition time information indicating the time when the current position was acquired, and the speed information indicating a speed of the vehicle 20a detected by the speed sensor. Transmission of the position information, the acquisition time information, and the speed information from the in-vehicle processing apparatus 40a to the assistance apparatus 60 is periodically performed.

At S414, the in-vehicle processing apparatus 40b transmits, to the assistance apparatus 60, the position information indicating a current position of the vehicle 20b which is based on the signal received from the GNSS satellite, the acquisition time information indicating the time when the current position was acquired, and the speed information indicating a speed of the vehicle 20b detected by the speed sensor. Transmission of the position information, the acquisition time information, and the speed information from the in-vehicle processing apparatus 40b to the assistance apparatus 60 is periodically performed.

At S430, the assistance controlling unit 260 of the assistance apparatus 60 determines whether to provide the traffic assistance for the vehicle 20 and the user terminal 82 based on information received at S402, S404, S412 and S414. For example, as described in connection with FIG. 3 and FIG. 4, etc., the calculating unit 220 calculates the positions of the vehicle 20 and the user terminal 82 at a specific point in time in the future based on the history of the position information and the speed information of the vehicle 20 as well as the history of the position information of the user terminal 82, and the assistance controlling unit 260 makes the approach determination based on the calculated position to determine whether the vehicle 20 and the user terminal 82 are approaching within the predetermined distance and/or whether the vehicle 20 and the another vehicle 20 are approaching within the predetermined distance at the specific point in time in the future. The assistance controlling unit 260 determines to provide the traffic assistance when the vehicle 20 and the user terminal 82 are approaching within the predetermined distance and/or when the vehicle 20 and the another vehicle 20 are approaching within the predetermined distance at a specific point in time in the future.

In the present embodiment, the assistance controlling unit 260 determines that the user terminal 82a and the vehicle 20a approach within the predetermined distance, and determines that the user terminal 82b and the vehicle 20b approach within the predetermined distance at a specific point in time in the future. Accordingly, at S432, the assistance controlling unit 260 transmits, by controlling the communication apparatus 290, assistance information instructing the in-vehicle processing apparatus 40a and the user terminal 82a to output a warning, to each of the in-vehicle processing apparatus 40a and the user terminal 82a. Further, at S434, the assistance controlling unit 260 transmits, by controlling the communication apparatus 290, the assistance information instructing the in-vehicle processing apparatus 40b and the user terminal 82b to output a warning, to each of the in-vehicle processing apparatus 40b and the user terminal 82b.

Upon receiving the assistance information from the assistance apparatus 60, at S406, the user terminal 82a notifies the user 80a of a presence of the vehicle 20 approaching the user 80a, using the Human Machine Interface (HMI) function included in the user terminal 82a. The user terminal 82a may notify the user 80a of the presence of a vehicle approaching the user 80a with sound. The user terminal 82a may notify the user 80a of the presence of the vehicle approaching within a predetermined time (e.g., within 5 seconds) according to the assistance information.

Upon receiving the assistance information from the assistance apparatus 60, at S416, the in-vehicle processing apparatus 40a notifies an occupant of the vehicle 20a of a presence of a user approaching the vehicle 20a, using the HMI function included in the in-vehicle processing apparatus 40a. The in-vehicle processing apparatus 40a may notify the occupant of the vehicle 20a of the presence of the vehicle approaching the vehicle 20a with sound and by displaying on a display apparatus included in the vehicle 20a. The in-vehicle processing apparatus 40a may notify the occupant of the presence of the user approaching within a predetermined time (e.g., within 5 seconds) according to the assistance information.

Upon receiving the assistance information from the assistance apparatus 60, at S408, the user terminal 82b notifies the user 80b of a presence of a vehicle approaching the user 80b, using the HMI function included in the user terminal 82b. The user terminal 82b may notify the user 80b of the presence of the vehicle approaching the user 80b with sound. The user terminal 82b may notify the user 80b of the presence of the vehicle approaching within a predetermined time (e.g., within 5 seconds) according to the assistance information.

Upon receiving the assistance information from the assistance apparatus 60b, at S418, the in-vehicle processing apparatus 40b notifies an occupant of the vehicle 20b of a presence of a vehicle approaching the vehicle 20b, using the HMI function included in the in-vehicle processing apparatus 40b. The in-vehicle processing apparatus 40b may notify the occupant of the vehicle 20b of the presence of the vehicle approaching the vehicle 20b with sound and by displaying on a display apparatus included in the vehicle 20b. The in-vehicle processing apparatus 40b may notify the occupant of the presence of the user approaching within a predetermined time (e.g., within 5 seconds) according to the assistance information.

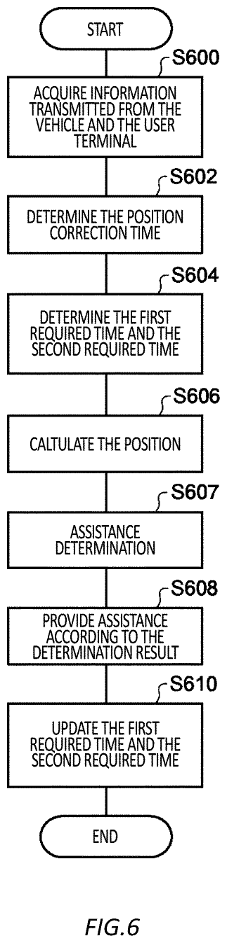

FIG. 6 shows one example of a flowchart regarding an assistance controlling method performed by the assistance apparatus 60. Processing in the present flowchart may be performed periodically.

At S600, the acquiring unit 210 acquires information transmitted from the vehicle 20 and the user terminal 82. For example, the acquiring unit 210 acquires position information, acquisition time information, and speed information transmitted from the in-vehicle processing apparatus 40 of the vehicle 20, and acquires position information and acquisition time information transmitted from the user terminal 82.

At S602, the calculating unit 220 determines the position correction time as described in connection with FIG. 3 and FIG. 4, etc. With the position correction time, the time at which the calculating unit 220 is to acquire the position information of the vehicle 20 and the user terminal 82 is determined. For example, the position correction time is the time which is 5 seconds later from the present time, and the like, as described in connection with FIG. 3 and FIG. 4, etc.

At S604, the calculating unit 220 determines the first required time T1 and the second required time T2. The calculating unit 220 may determine the times set by the setting unit 240 as the first required time T1 and the second required time T2.

At S606, the calculating unit 220 determines the time at which positions are to be calculated based on the information determined at S602 and S604, and calculates the position of each of the vehicle 20 and the user terminal 82 at that time based on the information obtained at S600.

At S607, the assistance controlling unit 260 makes the approach determination described above based on the positions calculated at S606, and determines whether to provide the traffic assistance for the vehicle 20 and the user terminal 82. If it is determined that the traffic support is to be provided to vehicle 20 and the user terminal 82, the control regarding the traffic assistance is performed at S608.

At S610, the setting unit 240 updates the first required time based on the time required to calculate the positions at S606 and updates the second required time based on the time required in processing of the approach determination at S608.

According to the assistance system 10 described above, the assistance apparatus 60 determines the time at which positions of the vehicle 20 and the user terminal 82 are to be calculated, by at least taking into account the first required time which is necessary for calculating the position of each of the vehicle 20 and/or the user terminal 82. This allows the accurate determination of whether the user terminal 82 and the vehicle 20 are approaching at a desired time, at a point in time when the calculation of the positions is complete.

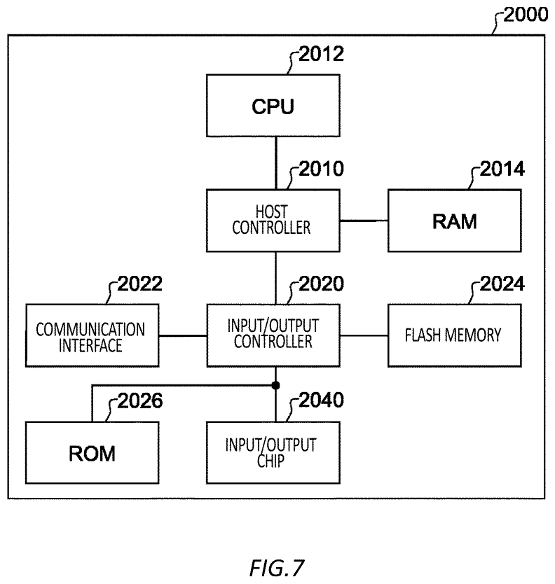

FIG. 7 shows an example of a computer 2000 in which a plurality of embodiments of the present invention can be entirely or partially embodied. A program installed on the computer 2000 can cause the computer 2000 to function as an apparatus such as the assistance apparatus 60 according to the embodiments or each unit of the apparatus, execute operations associated with the apparatus or each unit of the apparatus, and/or execute a process according to the embodiments or a step of the process. Such a program may be executed by a CPU 2012 in order to cause the computer 2000 to execute a specific operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

A program is provided via a network or a computer-readable storage medium such as a CD-ROM, a DVD-ROM, or a memory card. The RAM 2014, the ROM 2026, or the flash memory 2024 is an example of the computer-readable storage medium. The programs are installed in the flash memory 2024, the RAM 2014, or the ROM 2026, and executed by the CPU 2012. Information processing written in these programs is read by the computer 2000, and provides cooperation between the programs and the various types of hardware resources described above. An apparatus or a method may be actualized by executing operations or processing of information according to a use of the computer 2000.

For example, when a communication is executed between the computer 2000 and an external device, the CPU 2012 may execute a communication program loaded in the RAM 2014, and instruct the communication interface 2022 to execute communication processing based on processing written in the communication program. Under the control of the CPU 2012, the communication interface 2022 reads transmission data stored in a transmission buffer processing region provided in a recording medium such as the RAM 2014 and the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 and the like to be read into the RAM 2014, and execute various kinds of processing on the data on the RAM 2014. Next, the CPU 2012 writes back the processed data into the recording medium.

Various types of information such as various types of programs, data, a table, and a database may be stored in the recording medium and may be subjected to information processing. The CPU 2012 may execute, on the data read from the RAM 2014, various kinds of processing including various kinds of operations, information processing, conditional judgement, conditional branching, unconditional branching, information retrieval/replacement, or the like described herein and specified by instruction sequences of the programs, and write back a result into the RAM 2014. In addition, the CPU 2012 may retrieve information in a file, a database, or the like in the recording medium. For example, when multiple entries each having an attribute value of a first attribute associated with an attribute value of a second attribute, are stored in the recording medium, the CPU 2012 may retrieve an entry having a designated attribute value of the first attribute that matches a condition from these multiple entries, and read the attribute value of the second attribute stored in this entry, thereby acquiring the attribute value of the second attribute associated with the first attribute that satisfies a predetermined condition.

The programs or software modules described above may be stored in the computer-readable storage medium on the computer 2000 or in the vicinity of the computer 2000. A recording medium such as a hard disk or a RAM provided in a server system connected to a dedicated communication network or the Internet can be used as the computer-readable storage medium. A program stored in the computer-readable storage medium may be provided to the computer 2000 via a network.

The program which is installed on the computer 2000 and causes the computer 2000 to function as the assistance apparatus 60 may act on the CPU 2012 and the like to cause the computer 2000 to separately function as each unit of the assistance apparatus 60 (e.g., the position calculating apparatus 202, the assistance controlling apparatus 200, and the like). The information processing written in these programs are read by the computer 2000 to cause the computer to function as each unit of the assistance apparatus 60, which is specific means in which the cooperation of software and the various kinds of hardware resources described above cooperate. These specific means realize arithmetic operations or processing of information according to the intended use of the computer 2000 in the present embodiment, and the assistance apparatus 60 is thereby constructed to be specific for the intended use.

Various embodiments have been described with reference to the block diagrams and the like. In the block diagrams, each block may represent (1) a stage of a process in which an operation is executed, or (2) each unit of the apparatus having a role in executing the operation. A specific stage and each unit may be implemented by a dedicated circuit, a programmable circuit supplied with computer-readable instructions stored on a computer-readable storage medium, and/or a processor supplied with computer-readable instructions stored on a computer-readable storage medium. The dedicated circuit may include a digital and/or analog hardware circuit, or may include an integrated circuit (IC) and/or a discrete circuit. The programmable circuit may include a reconfigurable hardware circuit including such as logical AND, logical OR, logical XOR, logical NAND, logical NOR, and another logical operation, and a memory element such as a flip-flop, a register, a field programmable gate array (FPGA), a programmable logic array (PLA), or the like.

The computer-readable storage medium may include any tangible device capable of storing instructions to be executed by an appropriate device, and as a result, the computer-readable storage medium having instructions stored therein forms at least a part of a product including instructions which can be executed to provide means for executing processing procedures or operations specified in the block diagrams. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disc (DVD), a Blu-ray (registered trademark) disc, a memory stick, an integrated circuit card, or the like.

The computer-readable instructions may include an assembler instruction, an instruction-set-architecture (ISA) instruction, a machine instruction, a machine dependent instruction, a microcode, a firmware instruction, state-setting data, or either of source code or object code written in any combination of one or more programming languages including an object oriented programming language such as Smalltalk (registered trademark), JAVA (registered trademark), and C++, etc., and a conventional procedural programming language such as a “C” programming language or a similar programming language.

Computer-readable instructions may be provided to a processor of a general purpose computer, a special purpose computer, or another programmable data processing apparatus, or to programmable circuit, locally or via a local area network (LAN), wide area network (WAN) such as the Internet, or the like, and a computer-readable instruction may be executed to provide means for executing operations specified in the described processing procedures or block diagrams. Examples of the processor include a computer processor, a processing unit, a microprocessor, a digital signal processor, a controller, a microcontroller, and the like.

While the present invention has been described above by using the embodiments, the technical scope of the present invention is not limited to the scope of the above-described embodiments. It is apparent to persons skilled in the art that various alterations or improvements can be made to the above-described embodiments. It is also apparent from description of the claims that the embodiments to which such alterations or improvements are made can be included in the technical scope of the present invention.

It should be noted that the operations, procedures, steps, and stages, etc. of each process performed by an apparatus, system, program, and method shown in the claims, specification, or diagrams can be executed in any order as long as the order is not indicated by “before”, “prior to”, or the like and as long as the output from a previous process is not used in a later process. Even if the operation flow is described by using phrases such as “first” or “next” for the sake of convenience in the claims, specification, or drawings, it does not necessarily mean that the process must be performed in this order.

### EXPLANATION OF REFERENCES

10: assistance system
20: vehicle
40: in-vehicle processing apparatus
60: assistance apparatus
80: user
82: user terminal
90: road
200: assistance controlling apparatus
202: position calculating apparatus
210: acquiring unit
220: calculating unit
240: setting unit
260: assistance controlling unit
280: storage apparatus
290: communication apparatus
2000: computer;
2010: host controller;
2012: CPU
2014: RAM
2020: input/output controller;
2022: communication interface;
2024: flash memory;
2026: ROM
2040: input/output chip.

What is claimed is:

1. A position calculating apparatus comprising:
an acquiring unit which acquires position information of each of a plurality of moving objects and acquisition time information of each of the position information;
a calculating unit which calculates a position of each of the plurality of moving objects at a future time based on the position information and the acquisition time information; and
a setting unit which sets the future time by at least taking into account a calculation start time which is the time when the calculating unit starts calculating the position of each of the plurality of moving objects, and a first required time which is the time necessary for calculating the position of each of the plurality of moving objects.

2. The position calculating apparatus according to claim 1, wherein
the setting unit sets the future time based on time obtained by adding the first required time to the calculation start time.

3. The position calculating apparatus according to claim 2, wherein
for each of the plurality of moving objects, the calculating unit
calculates a time difference between the future time and acquisition time of a latest position of each of the moving objects; and
calculates a position of each of the moving objects at the future time based on the latest position of each of the moving objects and a moving speed of each of the moving objects and the time difference.

4. The position calculating apparatus according to claim 1, wherein
the setting unit measures a time required for the calculating unit to calculate the position of each of the plurality of moving objects, and sets the first required time used to set the future time based on the time measured.

5. The position calculating apparatus according to claim 1, wherein
the setting unit sets the first required time based on a number of the plurality of moving objects.

6. The position calculating apparatus according to claim 1, wherein
the setting unit sets the first required time based on a current processing load on the position calculating apparatus.

7. The position calculating apparatus according to claim 1, wherein
the plurality of moving objects includes a vehicle.

8. The position calculating apparatus according to claim 1, wherein
the plurality of moving objects includes a vehicle and a pedestrian.

9. The position calculating apparatus according to claim 2, wherein
the setting unit measures a time required for the calculating unit to calculate a position of each of the plurality of moving objects, and sets the first required time used to set the future time based on the time measured.

10. The position calculating apparatus according to claim 3, wherein
the setting unit measures a time required for the calculating unit to calculate a position of each of the plurality of moving objects, and sets the first required time used to set the future time based on the time measured.

11. The position calculating apparatus according to claim 2, wherein
the setting unit sets the first required time based on a number of the plurality of moving objects.

12. The position calculating apparatus according to claim 3, wherein
the setting unit sets the first required time based on a number of the plurality of moving objects.

13. The position calculating apparatus according to claim 4, wherein
the setting unit sets the first required time based on a number of the plurality of moving objects.

14. The position calculating apparatus according to claim 2, wherein
the setting unit sets the first required time based on a current processing load on the position calculating apparatus.

15. The position calculating apparatus according to claim 3, wherein
the setting unit sets the first required time based on a current processing load on the position calculating apparatus.

16. The position calculating apparatus according to claim 4, wherein
the setting unit sets the first required time based on a current processing load on the position calculating apparatus.

17. An assistance controlling apparatus comprising:
the position calculating apparatus according to claim 1; and
the assistance controlling unit which performs control regarding a traffic assistance for the plurality of moving objects based on a position of each of the plurality of moving objects calculated by the calculating unit.

18. The assistance controlling apparatus according to claim 17, wherein
the setting unit sets the future time based on time obtained by adding the calculation start time, the first required time, and a second required time which is the time necessary in processing for the assistance controlling unit to perform the control regarding the traffic assistance.

19. A position calculating method comprising:
acquiring position information of each of a plurality of moving objects and acquisition time information of each of the position information;
calculating a position of each of the plurality of moving objects at a future time based on the position information and the acquisition time information; and
setting the future time by at least taking into account a calculation start time which is the time when a calculation of the position of each of the plurality of moving objects is started in the calculating the position, and a first required time which is the time necessary for calculating the position of each of the plurality of moving objects.

20. A non-transitory computer-readable storage medium which stores a program, wherein the program causes a computer to function as:
an acquiring unit which acquires position information of each of a plurality of moving objects and acquisition time information of each of the position information;
a calculating unit which calculates a position of each of the plurality of moving objects at a future time based on the position information and the acquisition time information; and
a setting unit which sets the future time by at least taking into account a calculation start time which is the time when the calculating unit starts calculating the position of each of the plurality of moving objects, and a first required time which is the time necessary for calculating the position of each of the plurality of moving objects.
